(19) United States
(12) Patent Application Publication
(10) Pub. No.: US 2005/0102382 A1
(43) Pub. Date: May 12, 2005

(54) System and method for network management using instant messaging

(76) Inventors: Glenn MacGregor, Watertown, MA (US); Scott MacGregor, Watertown, MA (US)

Correspondence Address: BANNER & WITCOFF, LTD., 28 STATE STREET, 28th FLOOR, BOSTON, MA, 02109-9601, US

(21) Appl. No.: 09/874,650

(22) Filed: Jun. 4, 2001

(51) Int. Cl. G06F 15/173

(52) U.S. Cl. 709/223

(57) ABSTRACT

A network management system includes a plurality of network cells, each network cell associated with at least one monitored network node or element. The system also includes an instant messaging server in communication with the network nodes, and a client workstation, in communication with the instant messaging server, performs the monitoring functions. The system utilizes the instant messaging capability for acquiring, caching, transferring, storing, analyzing, correlating, and displaying network management information from the network nodes. The network cell provides for either manual or automatic control of a selected network node or element, and converts the respective management protocols into a single format that is integrated into an instant messaging data bus. Network management events from disparate and diverse network entities are sent to one or more instant messaging ‘group chat’ environments to facilitate the consolidation, processing and correlation of network events.

### CROSS REFERENCE TO RELATED APPLICATION

The present application is related to Provisional Application serial No. ______ entitled “Instant Messaging for Network Management” filed 25 May 2001.

### FIELD OF THE INVENTION

The present invention relates to network management and, more particularly, to a method and system for providing real-time monitoring of computer network nodes.

### BACKGROUND OF THE INVENTION

As the use of computers and computer networks becomes more ubiquitous for a large variety of tasks, the need to exchange information among computers also increases. As a result, networks for interconnecting computers, to allow such exchange of information, continue to grow. This growth occurs not only in the number of networks, but also in their size and complexity, as evidenced by the expanding use of local area networks (LANs), wide area networks (WANs), enterprise-wide networks (which might include several WANs) and, ultimately, world-wide networks, such as the Internet.

To ensure reliable communications between computers and associated network elements, the networks themselves must be monitored on a regular basis. In general, the management of a network involves continued monitoring of the operating state of components which form the network, controlling those components to provide optimal performance under varying conditions, and troubleshooting sources of problem on the network without affecting network performance. To this end, various operating models have been proposed for network management.

In the operation of these models, information pertaining to the performance of components in the network is obtained, for example, by management agents running on those components, and provided to a management process via an established protocol. The Simple Network Management Protocol (SNMP) was developed for networks which operate on the basis of the Internet protocol (IP or TCP/IP). Similarly, OSI-based networks employ the Common Management Information Protocol (CMIP) to transfer information regarding the operation of the network.

This information is reported to a management process running on a central station which could be, for example, the main server on a given network. In essence, the management process provides a network manager with a list of all of the components on the network, e.g., routers, bridges, repeaters and the like, along with information regarding their configuration, operational status, and the like. Given that a network manager maintains a list of every network entity and that these entities are of varied and diverse complexity, a challenge for the network management software is in representing entities and providing a common distributed interface to the management data.

What is needed is an improved method for managing networks.

### SUMMARY OF THE INVENTION

The present invention utilizes an instant messaging system for providing a network management capability to acquire, cache, transfer, store, analyze, correlate and display network management information from diverse network components. The network management information is acquired by means of a network cell provided near each monitored network element. The network cell provides for either manual or automatic control of a selected network element, and converts the management protocols of the network element into a single format that is integrated into an instant messaging data bus. Network management events from disparate and diverse network entities are sent to one or more instant messaging ‘group chat’ environments to facilitate the consolidation, processing and correlation of network events.

### BRIEF DESCRIPTION OF THE DRAWINGS

The invention description below refers to the accompanying drawings, of which:

FIG. 1 is a simplified block diagram of a conventional network management system;

FIG. 2 is a simplified block diagram of a network management system implementing the present invention;

FIG. 3 is a simplified block diagram of an instant messaging architecture;

FIG. 4 is an illustration of an instant messaging architecture used for network management;

FIG. 5 is a functional block diagram of a network cell;

FIG. 6 is a simplified block diagram of an exemplary network;

FIG. 7 is a simplified block diagram of the network of FIG. 6 in which network cells are included to illustrate a configuration in which network management is accomplished using an instant messaging architecture; and

FIG. 8 is a screen shot of a standard instant messaging client as used for network management.

### DETAILED DESCRIPTION OF A PREFERRED EMBODIMENT

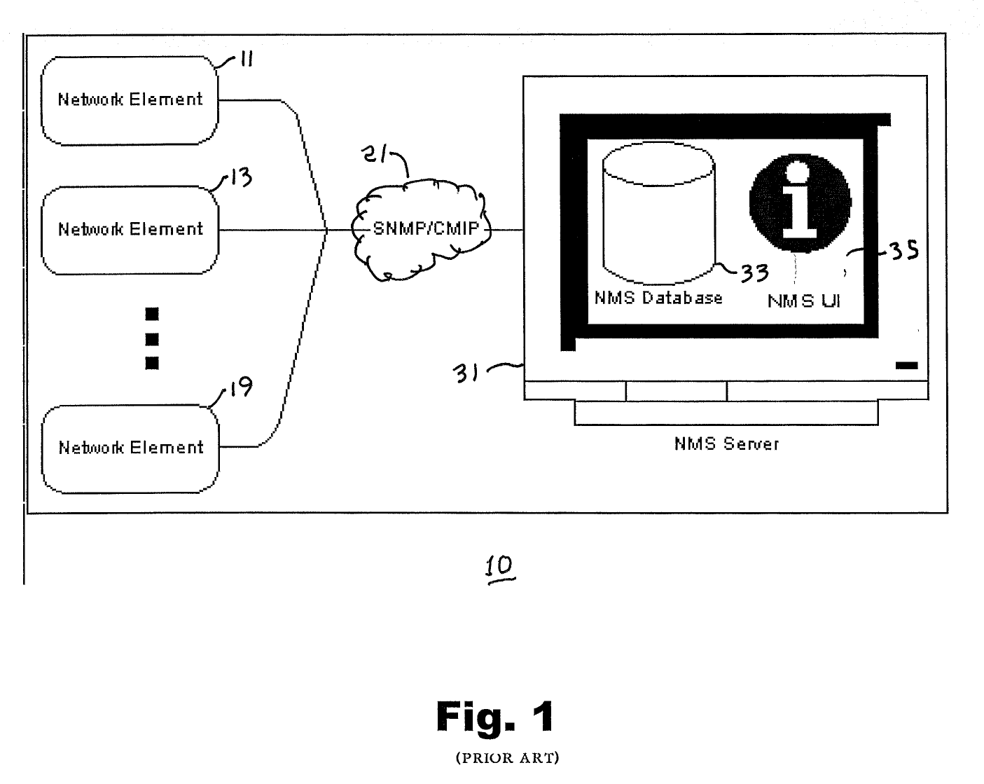

There is shown in FIG. 1 a conventional network management system 10 including a network management system server 31 with a network management system database 33 and a user interface 35. The network management server 31 functions to monitor a plurality of network elements, here represented as network elements 11, 13, through 19, connected to the network management server 31 via a network 21, such as a LAN operating in accordance with the Simple Network Management Protocol (SNMP) or Common Management Information Protocol (CMIP).

Among the functions of the network management system 10 are the acquisition of network and service operations data, and the dissemination of network management information. Additionally, the network management server 31 stores and analyzes information obtained from the network elements 11-19 from which data can be presented and reported. Using these capabilities, the network management system 10 can manage and control network and service resources for the network elements 11-19.

As used herein, the term ‘network and service operations data’ includes data from network devices, data from network segments, and data from applications. Data from a particular network element is acquired from a management interface resident in the respective network element. In the present state of the art, management interfaces vary from network element to network element and can be SNMP, TCP/IP, craft terminal, serial protocol or contact closures. Network segment data is calculated from network utilization information or acquired from a transmission device (not shown) that monitors the segment. Application data is acquired or monitored by simulating the use of the particular Application and calculating the resultant performance characteristics. The capability of the network management system 10 to acquire and disseminate network management information is important because clients (i.e., the consumers of the information) are often remote from the source of data. Information is provided to the client by moving the data from the point of acquisition (e.g., at the network elements 11-19) to the network management system database 33, and moved from the network management system database 33 to the client.

Network management architecture has evolved to include additional features, including a network demarcation probe. The network demarcation probe acquires data from network elements and applications, and monitors network services. The probe is used to acquire data about the health and performance of the network components. Usually, the probe is placed remote from the central database and at network demarcation points near the respective network element, segment or service being monitored.

Another network management feature is a ‘data warehouse,’ which is a central or distributed database that provides a common information platform for the formatting, storage, archiving and retrieval of element network and service level information. In response to the complexity and amount of network management data present, the data is analyzed, correlated and stored in the secure location of the data warehouse. The analysis and correlation functions serve to filter the large volume of information into a meaningful real-time snapshot. The stored data is useful for historical archiving and for reporting and trending.

Another feature, a ‘decision support system,’ integrates with the data warehouse to format and present network and service level information, as well as analyzed and correlated data, to operators and clients of the network infrastructure. This information is presented and reported for the purpose of resource allocation, troubleshooting and network health decision-making. The reports are generated from stored data and are formatted for a given audience (e.g., operations, engineering, and management).

There may also be provided to management clients, visual and audio access to network information for administrators, operators, managers and users. The management clients can be remote from the network, the network equipment, and the central database. This management and control of network devices is essential to provide manual or automatic control of remote network resources. An operator console or a user interface object facilitates manual control, and automatic control is facilitated according to status conditions and programmable logic.

Addition of even more sophisticated remote sites, co-located equipment and outsourced services has extended the network management architecture to include remote and automatic control, and flexible network user domain configuration. Remote and automatic control is a feature that provides a control interface to network elements at the probe/cell level. Control can be performed manually by network operators or automatically by the cell. The network user domain refers to a segmented portion of the management interface that is available to a user group. A user group will typically have a profile that links to a domain within the managed network. For example the domain of a network administrator is the entire management interface, whereas the domain of a web-hosting customer may be limited to a portion of the web server, including, for example, a switch and a WAN router.

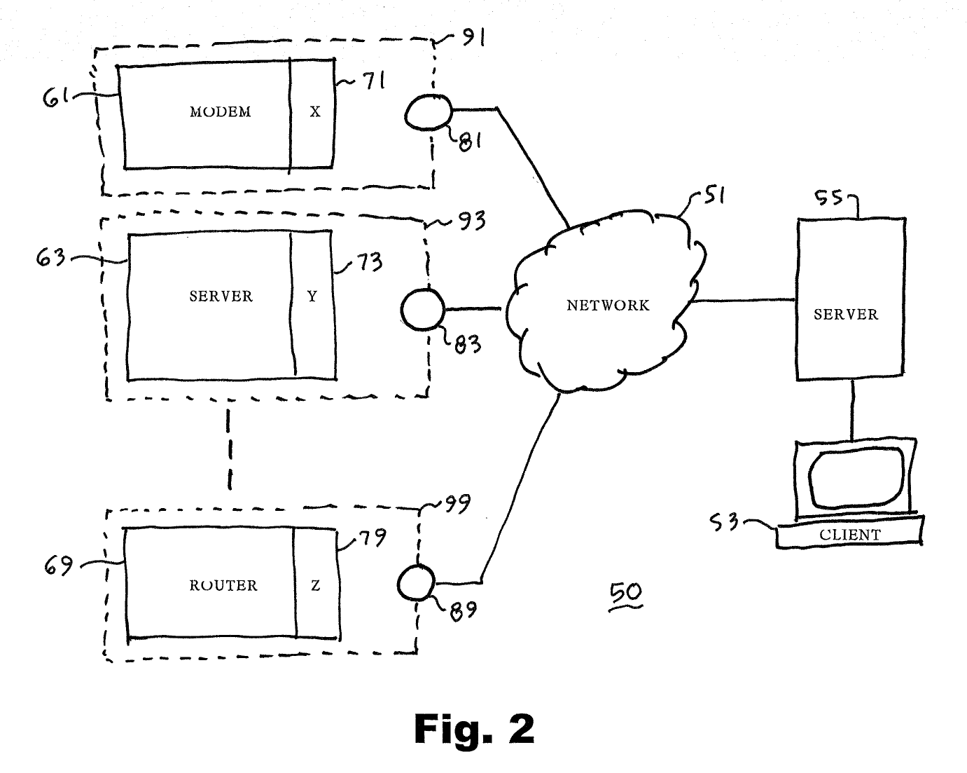

There is shown in FIG. 2 a network management system 50 including a network management server 55 providing access to a network 51 for a client 53. The client 53 manages the various nodes in the network management system 50, here represented by devices including a modem 61, a server 63, and a router 69. The modem 61 is managed via a modem management protocol 71, the server 63 is managed in accordance with a server management protocol 73, and the router 69 is managed using a router management protocol 79.

The network management system 50 includes a modem network cell 81 located near to or within the modem 61 and connected via the network 51 to the network management server 55. The modem network cell 81 is a software entity that acquires data from a network device, segment, or service, such as the modem 61, and represents the corresponding device, segment, or service and its data as, in this case, a modem virtual instant messaging (VIM) user 91. The modem VIM user 91 can be queried by other real or VIM users, and can send unsolicited notifications to other real or VIM users.

In general, the modem VIM user 91 is ‘seen’ by the network management server 11 as a relatively simple object (i.e., the VIM user 91) rather than as the relatively more complex modem 61. Similarly, a server network cell 83 provides for presenting the server 63 as a VIM user 93, and a router network cell 89 provides for presenting the router 69 as a VIM user 99.

It should be understood that a single cell can monitor more than one network element. Accordingly, the single cell resides near the monitored network elements in such a configuration. Alternatively, one cell can be used to monitor only a single network element, as exemplified in the illustration provided. The particular configuration used depends upon the needs of the network management system 50. In way of example, if the disk space on several different servers is being monitored, it may not be desirable to assign a separate cell to each of the servers, but rather to use a single cell for monitoring all the disk space. In such a configuration, one cell on one server will also communicate with all the other servers. In comparison, for monitoring stand-alone routers, the preferred configuration may be to assign a separate cell to each of the routers. Each of the cells 81-89 thus has the capability to represent a single IM user, or multiple IM users.

The network cells 81-89 include software to acquire, store, calculate, and disseminate network and service level management information. The network cells 81-89 secured from unauthorized access by restricting all communication to server-based communication. All communication to the cells is managed by the server 53a. The server 53a provides security access control for network user groups by limiting communication to authenticated users, such as to the client 53. This allows a configuration in which a client that is authenticated within a particular group can be granted permission to access one or more network elements resident in that group.

The data acquired by the network cells 81-89, including real-time and recent history data, is stored in a distributed XML and relational database, as described in greater detail below. The distributed database may be partly resident within the network cell and partly in a central database, or the entire database may reside centrally on a server. The network cells 81-89 function to cache data locally in the event the connection between the network cell and server is lost. The network cells 81-89 store real-time point values in internal XML files. The recent historical data is stored to maintain data integrity. More complete history is stored at the central database. The network cells 81-89 can perform basic calculations on parameters at the time of an event or threshold. The calculation can cause an action like setting a point or sending a notification. The cell polls and monitors the network objects using a nested polling scheme. Certain points and parameters may be polled more frequently than other points and parameters based on the relative importance of those parameters to network health and performance.

A ‘query’ is an instant messaging chat between a network cell and another network management object. A ‘notification’ is a standard IM message sent to a group of one or more management clients. The network cells 81-89 disseminate data by responding to queries and sending notifications on an event or threshold. The query appears to the client as a direct exchange of information with a network element. In way of example a simple query and response is:

| | |
|---|---|
| Client: | get bitrate |
| Device: | bitrate=128000 |

The network cells 81-89 also support a ‘natural language’ query to facilitate the access of information between clients, including the client 53, and other network cells. In a natural language query, commands may include, for example, ‘get,’ ‘set.’ ‘show,’and ‘list.’ A group chat event manager (GEM) uses the existing notion of group chat between users to consolidate events into logical groups. The GEM allows Applications and clients to seamlessly share event data, without adding overhead and burden to limited bandwidth resources.

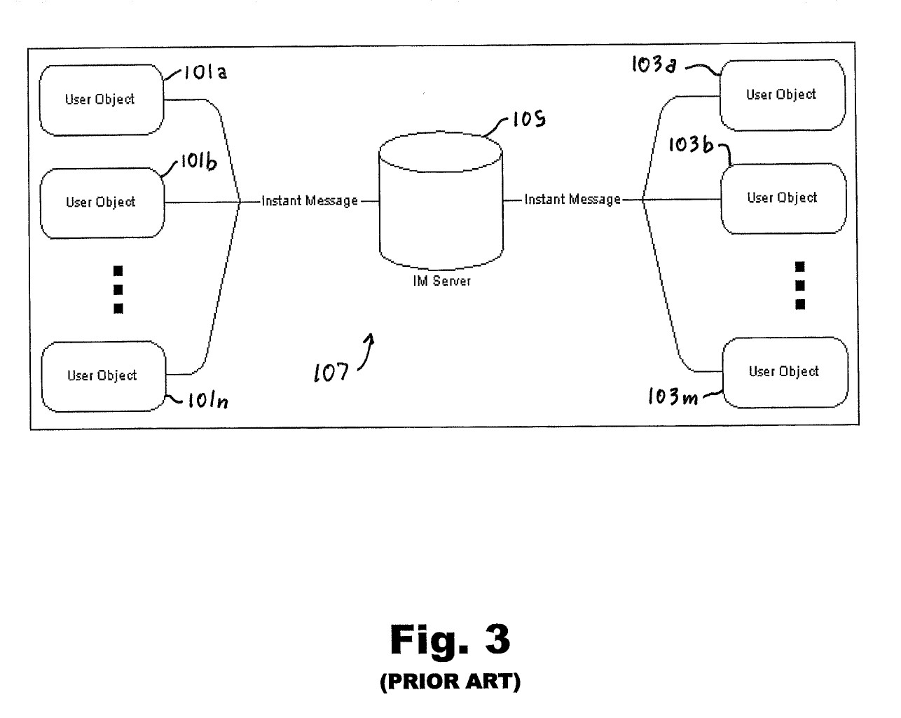

As can be seen with reference to FIG. 3, Instant Messaging (IM) is a framework technology used to detect the presence of users, here represented by user objects 101a-101n and user objects 103a-103m, on a network 107 and is also used to provide a mechanism for passing messages between the user objects 101a-101n and 103a-103m. The architecture of instant messaging includes users that are dispersed across a geographic region communicating with one another, and in groups, through an instant messaging server 105. Instant messaging systems further have user interface objects-clients that present real-time (i.e., ‘instant’) information to the user objects 101a-10n and 103a-103m. Instant messaging also has a system for encoding and transporting data across wide areas and provides a framework for secure network communications. The network protocol used for instant messaging can also be used for network management, as the requirements are identical: transport secure-data across a wide area network in real time. The requirements for instant messaging also provide for a protocol that is flexible and scalable. Additional information related to instant messaging is provided in the white papers “Instant Messaging Architecture Overview” and “Instant Messaging Protocol Overview” authored by Jabber.com, having offices in Denver, Colo., the white papers incorporated herein by reference.

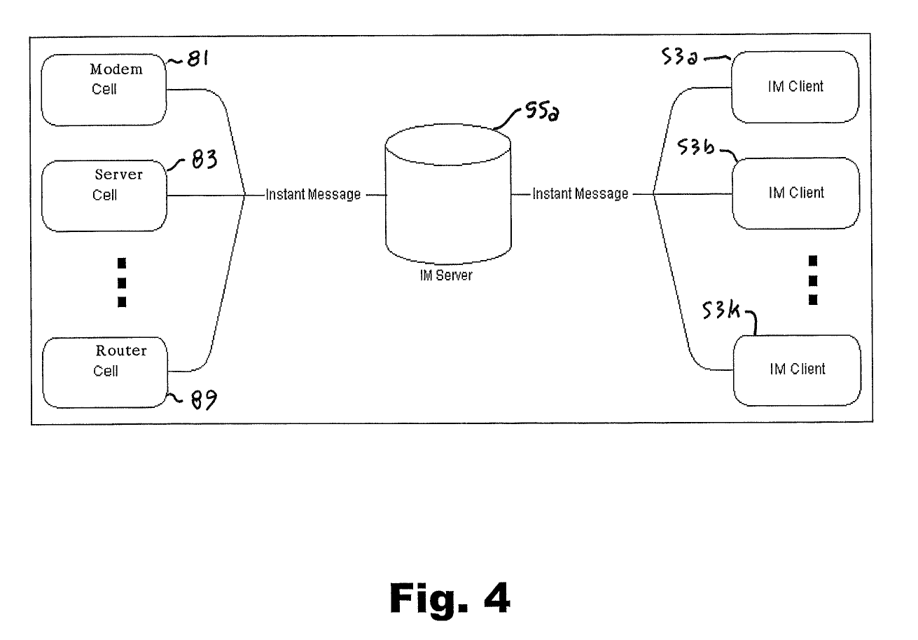

The network management system 50, in FIG. 2, can thus be represented by the simplified functional diagram of FIG. 4, in which the network cells 81-89 function as IM clients that communicate with the modem 61, the server 63, and the router 69, respectively, instead of with, for example, user objects 101a-101n. Accordingly, the VIM users 91-99 become IM clients that present information via an IM server 55a to any of a number of clients, here represented by an IM client 53a, an IM client 53b, through an IM client 53k.

Each of the network cells 81-89 comprises a software module, preferably including a single executable file, that is compiled in a modern programming language such as C++ or Java Perl. The software module can be provided as software in a storage medium, or can be pre-installed in a host device. The host device may be a functional hardware device such as a router or switch, or may be a general purpose computing device such as a desktop computer or server.

Network cells 81-89 automatically function when the respective host devices are in operational states and after each of the network cells 81-89 has been pre-configured with a corresponding name and with the name of the server 55a. In a preferred embodiment, the name and server are provided in a configuration file attached to the executable file. Each of the network cells 81-89 communicates with the IM server 55a using a cell name and the server name, and requires supplemental configuration information to specify requisite network management behavior. The supplemental configuration defines: i) the type of network element 71-79 being polled, ii) the points that are relevant on the network element 71-79, iii) derived points, iv) math and logic operations, and v) triggers and thresholds. The network cells 81-89 acquire specific configuration from a database on the IM server 55a or from a local XML database cache.

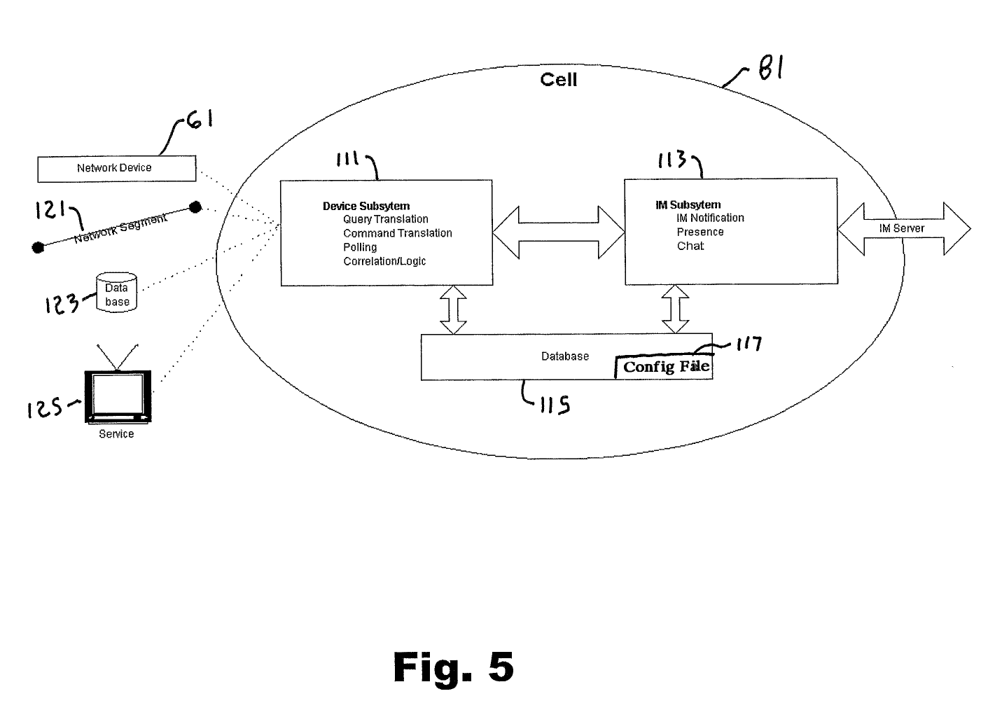

As shown in FIG. 5, the network cell 81 includes a device subsystem 111, an IM subsystem 113, and a local database 115. The configuration and functions of the network cells 83 through 89 are similar to those described herein for the network cell 81. The device subsystem 111 interfaces with a corresponding network element, such as the modem 61, a network segment 121, a database 123, or an application 125. The device subsystem 111 provides command and query translation between the network cell 81 and the modem 61. The device subsystem 111 also provides the polling capability for the network cell 81. The IM subsystem 113 interfaces with the instant messaging functions of the IM server 55a by creating an IM notification transmittal, communicating the presence of the network cell 81, and responding to query-chat activities.

The cell 81 is installed on the modem 61, or on the network segment 121, the database 123, or the application 125, as a single executable file with a minimal configuration file 117 attached. The configuration file 117 contains at least the minimum information necessary for the cell to operate. Such information includes:
i) the name of the IM server 55a, ii) the user name of the cell 81, iii) the password used in the communication between the cell 81 and the IM server 55a, and iv) the function of the cell 81. The function of a cell is determined by the network element with which the cell is associated. This information can reside in a separate file which an Application can read, or may be compiled into the Application if space or resources are limited. The cell 81 then logs into the IM server 55a as the user specified by the user name and sends a request to the server 55a using the cell type of the cell 81.

The configuration file 117 resides on the database 115 but may be transported to the cell 81 from the IM server 55a via instant messaging. When the cell 81 is initiated, only the minimal information is required to run the cell 81. The minimal information includes the IM username of the cell 81, a password (if used), the name of the IM server 55a (or other server to which the cell 81 may be talking), and the function of the cell 81 (e.g., a cell talking to a Cisco 3640 router). It should be understood that, while all cells are similar, the respective configuration makes the cells different. Thus, a first cell which talks to a Cisco 3640 router is the same as a se4cond cell which talks to a Baynetworks switch stack. But, the first cell performs different functions from the second cell. Accordingly, the initial query from the first cell to the corresponding server after login may be, ‘I am talking to a Cisco 3640 router; give me the configuration for that router.’

The configuration file is created by the network manager and put on the IM server 55a. When the cell 81 is installed, the cell 81 asks the IM server 55a what the username, password, and IM server name are, as well as what the cell 81 will be talking to (e.g., a Cisco 3640 router). Preferably, the cell 81 periodically queries the IM server 55a for the configuration. In this manner, if the configuration for the Cisco 3640 router changes, it is not necessary to communicate with all the cells monitoring this type of component. The cells will obtain the new configuration for the Cisco 3640 router, for example, with the periodic queries.

Configuration data initially is a ‘template.’ Using the above example, the Cisco 3640 router can have between one and eight Ethernet interfaces. If the network management system 50 comprises twenty such routers, it is not necessary to retain twenty configuration files if such a template is used. Thus, the information provided by the configuration file will include a response such as ‘the Cisco 3640 router can have up eight Ethernet interfaces, but just get the following information for all valid interfaces.’

That request sent by the cell 81 is answered by the IM server 55a. The response from the IM server 55a includes additional configuration information for the cell 81, including all polling, presence, logic and history data. The configuration information instructs the cell 81 how to interact with the modem 71 and how to interact with the IM server 55a. This configuration information may include real time configuration data as well as static configuration data. Once the cell 81 has acquired the additional configuration information, the information is cached locally in the event that there is a network failure between the cell 81 and the server 55a. When coming on to the system, the cell 81 will initially attempt to retrieve corresponding configuration information from the server 55a. If the cell is not able to obtain the information, then the locally-cached configuration information will be used.

In general, cells have the ability to update their configuration dynamically depending on the environment they are in. This update will happen locally and on the server 55a for the next time that the cell 81, or another cell, needs the configuration information. The cell 81 has the ability to query multiple IM servers so as to provide for redundancy of configuration information.

When operating, the network cell 81 polls parameters on the modem 61 and listens for unsolicited messages from the modem 61. The network cell 81 monitors these parameters and messages, and perform calculations and derivations on the obtained values. Subsequently, the network cell 81 sends messages and notifications to the IM server 55a upon the occurrence of a configured threshold or trigger. This notification may also be distributed to other interested parties, such as IM clients 53a through 53k, according to standard instant messaging behavior.

The network cell 81 represents the modem 61 as an instant messaging user. This instant messaging user or Virtual Instant Messaging user (VIM) so presented appears as the source of messages and notifications upon the occurrence of the trigger or threshold. The VIM provision also enables the IM clients 53a through 53k to query the modem 61 via the VIM. These queries are performed as a chat with the modem 61. In way of example, a chat query of ‘get frequency’ might produce a response of ‘the frequency is 4650.00 kHz’ from the modem 61.

The server 55 also provide restricted user and group access, similar to UNIX-based file permissions, on all records and sub records. These records represent cell data and ultimately provide the access control to the cell. The network cells 81-89 also have the capability to encrypt data using standard techniques such as Secure Sockets Layer (SSL). The network cells 81-89 enable devices, networks and network objects to be managed with simple and powerful tools on a world-wide instant messaging network. In addition to representing a device, network or network object each of the network cells 81-89 can represent a database, a segment of a database, and tables and records within a database. The network cells 81-89 fully utilize the notion of presence for providing concise status and alert information about the respective network elements 61-69.

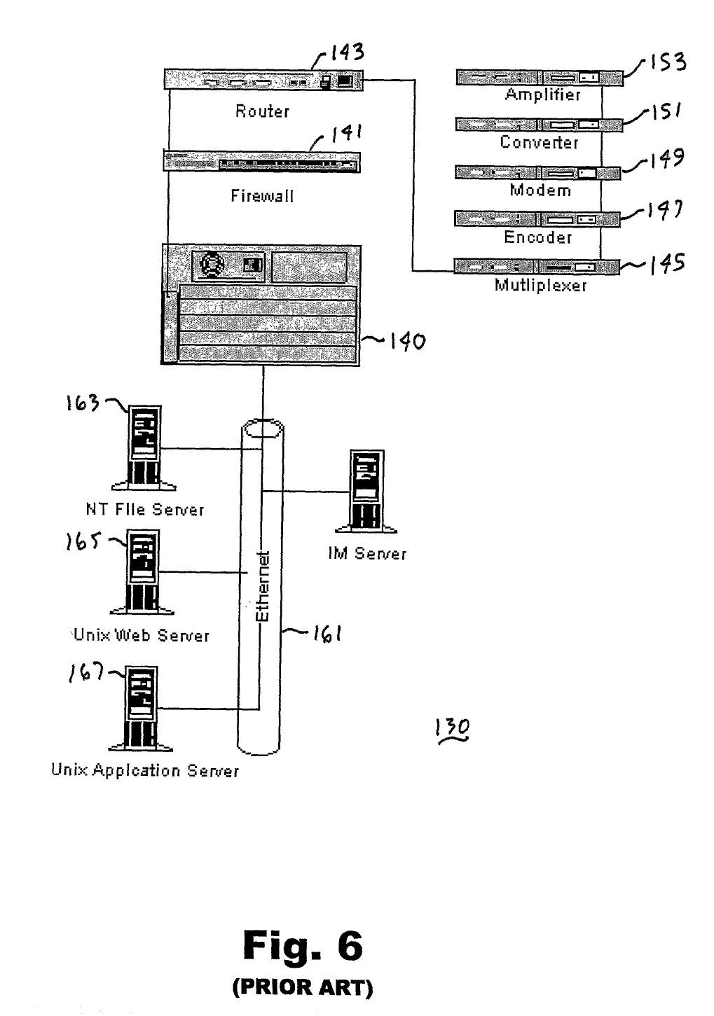

An exemplary network 130, of the type in which the present invention can be advantageously employed, is illustrated in the block diagram of FIG. 6. The network 130 includes a heterogeneous mix of wired and wireless network elements which present different management interfaces to a management system. In the illustration provided, a system 140 includes network elements such as a firewall 141, a router 143, a multiplexer 145, an encoder 147, a modem 149, a converter 151, and an amplifier 153. A portion of the network 130 may be affected by facilities and environmental conditions that also need to be monitored. Other network elements, such as an NT file server 163, a Unix web server 165, and a Unix application server 167 are connected via an Ethernet 171 and may be geographically dispersed.

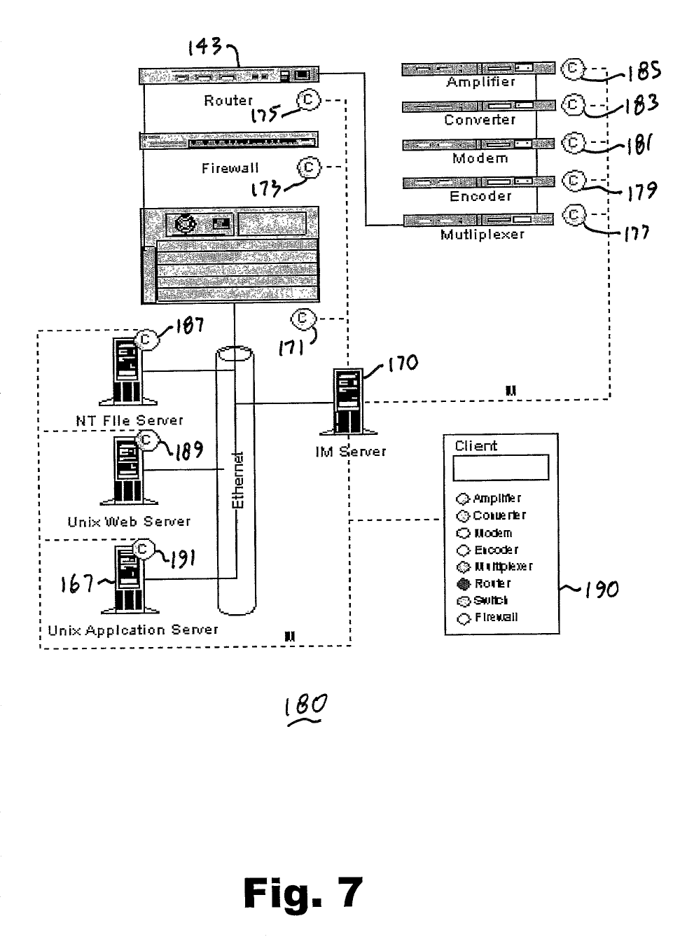

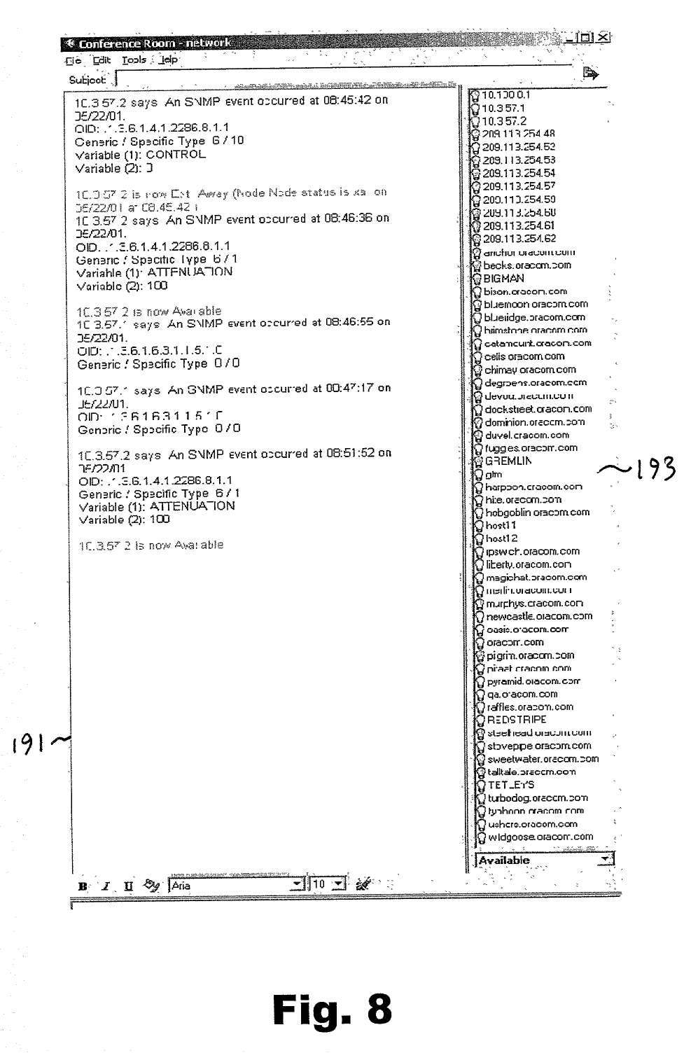

An equivalent managed network 180 is shown in FIG. 7. A plurality of network cells 171-191 are in communication with an IM server 170, as indicated by dashed lines. The network cell 175, for example, is used to represent the router 143 as an instant messaging user, and the network cell 191 is used to represent the Unix application server 167. Monitoring information is provided to a client 190 by means of a display similar to a screen 191 shown in FIG. 8. The screen 191 includes a network element section 193 providing a list of the network elements being monitored along with an icon (here represented by a light bulb), where the color of the icon indicates the status of the associated network element.

It will be recognized, of course, that the practical applications of the managed network 180 are not limited to networks of heterogeneous makeup, or to networks that are geographically dispersed. Other forms of networks, such as IP, ATM or SONET, which contain more than one network entity, can benefit from the features of the invention.

While the invention has been described with reference to particular embodiments, it will be understood that the present invention is by no means limited to the particular constructions and methods herein disclosed and/or shown in the drawings, but also comprises any modifications or equivalents within the scope of the claims.

1. A network management system suitable for use in monitoring and managing a plurality of network nodes, services, and segments, said system comprising:
a plurality of network cells, each said network cell associated with a respective network element;
an instant messaging server in communication with said network elements; and
a client workstation in communication with said instant messaging server, for performing managing and monitoring functions.

2. The network management system of claim 1 wherein said network element comprises a member of the group consisting of: a network device, a network node, a network segment, a database, and a service.

3. The network management system of claim 1 wherein said network cell comprises a device subsystem in communication with said network element for performing at least one of: query translation, command translation, polling, correlation, and logic.

4. The network management system of claim 1 wherein said network cell comprises an instant messaging subsystem in communication with said instant messaging server for performing at least one of: instant messaging (IM) notification, IM presence, and IM chat.

5. The network management system of claim 1 wherein said network cell comprises a local database.

6. The network management system of claim 5 wherein said local database includes a configuration file.

7. The network management system of claim 1 wherein said client workstation includes a screen providing a list of network elements being monitored.

8. The network management system of claim 7 wherein said screen includes an icon having a color indicative of the status of an associated network element.

9. A method of monitoring and managing a plurality of network elements, such as nodes, devices, services, databases, and segments, said method comprising the steps of:
providing a client workstation for performing management and monitoring functions;
associating at least one network cell with a respective network element; and
providing a communication link between an instant messaging server and said network cell; and
providing a communication link between said instant messaging server and said client workstation.

10. The method of claim 9 wherein said network cell communicates with said instant messaging server to provide configuration information.

11. The method of claim 10 wherein said configuration information includes at least one of: type of network element being polled, relevant points on said network element, derived points, math operations, logic operations, triggers, and thresholds.

12. The method of claim 9 further comprising the step of providing between said network cell and said respective network element at least one of: command translation, query translation, polling, correlation, and logic.

13. The method of claim 9 further comprising the step of interfacing with instant messaging functions of said instant messaging server by performing at least one of the following: creating an instant messaging notification transmittal, communicating the presence of said network cell, and responding to query-chat activities.

14. The method of claim 9 further comprising the step of polling parameters on said network element via said network cell.

15. The method of claim 9 further comprising the step of monitoring parameters and messages from said network element via said network cell.

16. The method of claim 15 further comprising the step of performing calculations and derivations on the values obtained in said step of monitoring parameters and messages from said network element.

17. The method of claim 9 further comprising the step of sending messages via said network cell to said instant messaging server upon the occurrence of a configured threshold or trigger.

18. A computer-readable medium for providing a method of monitoring and managing a plurality of network elements, said method comprising the steps of:
providing a client workstation for performing management and monitoring functions;
associating at least one network cell with a respective network element;
providing a communication link between an instant messaging server and said network cell; and
providing a communication link between said instant messaging server and said client workstation.
